(19) United States
(12) Patent Application Publication
(10) Pub. No.: US 2015/0123060 A1
(43) Pub. Date: May 7, 2015

(54) Movable Center Pivot Fence

(71) Applicant: NUtech Ventures, Lincoln, NE (US)

(72) Inventors: Jason Gross, Litchfield, NE (US); Chris Henry, Stuttgart, AR (US)

(21) Appl. No.: 14/071,761

(22) Filed: Nov. 5, 2013

(51) Int. Cl. A01K 3/00

(52) U.S. Cl. CPC A01K 3/005
USPC 256/10

(57) ABSTRACT

This invention relates to a movable electric fence that includes an electric wire suspended beneath a center pivot by removable hangers and clamps. It also includes a system for controlling the movement of herd animals. The movable electric fence progresses radially, increasing the herd's grazing area in a controlled manner.

### FIELD OF THE INVENTION

The invention relates to a movable electric fence for controlling livestock grazing.

### BACKGROUND OF THE INVENTION

Electric fences are commonly used in the farming industry as a means of temporary fencing. The typical construction is concrete reinforcing bar (rebar) posts with plastic insulators which hold an electrified wire. The most common use of the temporary electric fence is as a simple perimeter fence to enclose a pasture or previously harvested field, but those familiar with the art have long recognized that there are limitations to any general enclosure of this type. When given access to an entire field, cattle tend to overeat resulting in inefficiency of the available food and damage to vegetation in pastures. Vegetation is further damaged as the cattle lie down and make trails throughout the field. Furthermore, cattle tend to congregate in certain areas of the field resulting in an uneven disbursement of manure. As a result of these challenges, the need for a movable fence has long been acknowledged.

The non-permanence of electric fences have allowed for greater mobility than common regular fences, but the electric fences were generally only movable by the physical effort of the herdsperson. An alternative has been to create smaller pens with a field and drive the cattle from pen to pen. The time consuming nature of moving each post individually or of checker boarding and entire field with smaller pens has prevented efficient regulation of herd movement.

To regulate herd movement beyond that accomplished by a simple perimeter fence, prior art has attempted a number of other designs. Other designs have included a small pen on wheels driven by a motor (U.S. Pat. No. 4,341,181A), fences on skids designed to slow the cattle's progress through a field (U.S. Pat. No. 3,972,307A), and a two-arm center pivot with a permanently attached electric fence used to force cattle through a spiral labyrinth of stationary electric fence laid out in the field (U.S. Pat. No. 4,721,061A). Since these designs, there has been a need for an easily used and inexpensive alternative.

### SUMMARY OF THE INVENTION

The following discloses an easily used and inexpensive electric fence for controlling the movement of animals in a field. The design is comprised of simple parts that are readily attachable to any preexisting center pivot. All components of the movable electric fence are removable and setup requires no welding or drilling upon the existing center pivot. The disclosure also features a system for using the movable electric fence which requires minimal additional fencing laid out in a simple pattern consisting of a perimeter fence and one radial fence extending from the center pivot's axis to the perimeter fence. The system meets the need for an easily used and inexpensive movable fence and solves the problems of herd overeating, trampling, and manure dispersal.

### BRIEF DESCRIPTION OF THE DRAWINGS

FIG. 1 shows a side view of electric fence attached to a pivot with all of its parts.

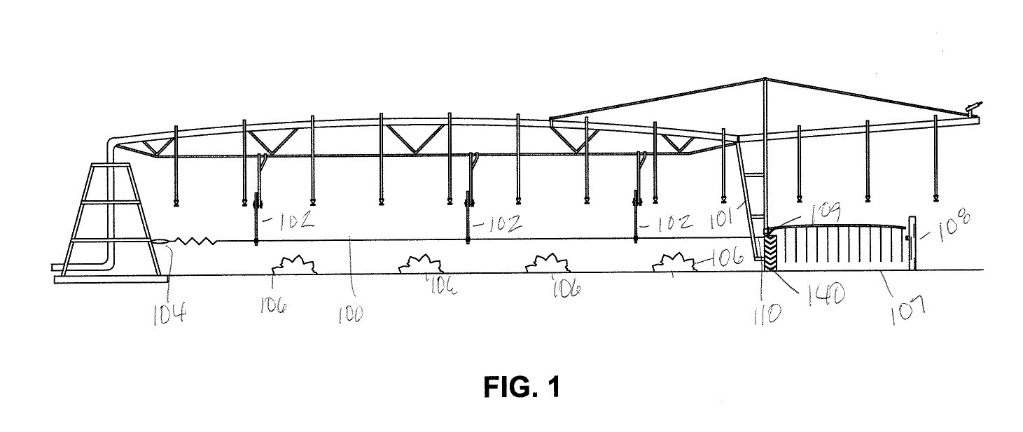

FIG. 2A shows a detailed view of how the truss rod hanger attaches to the truss rod.

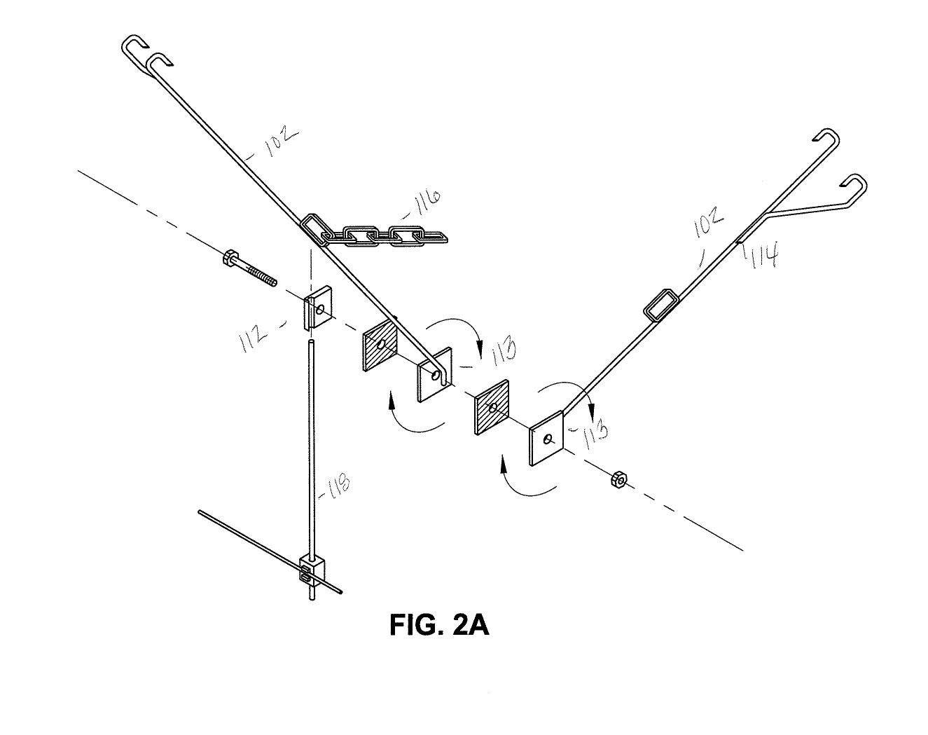

FIG. 2B shows a truss rod hanger with its parts.

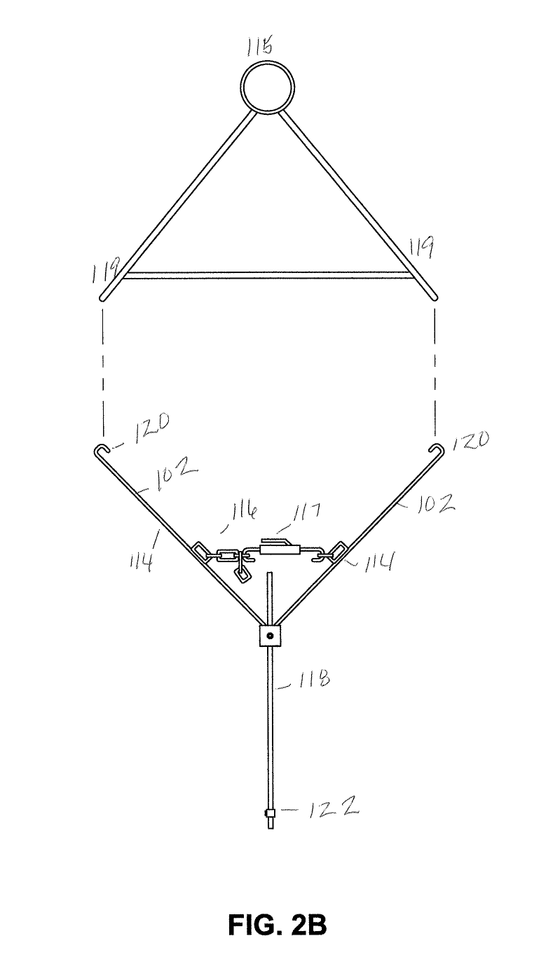

FIG. 3 shows a drive pipe clamp with an insulator.

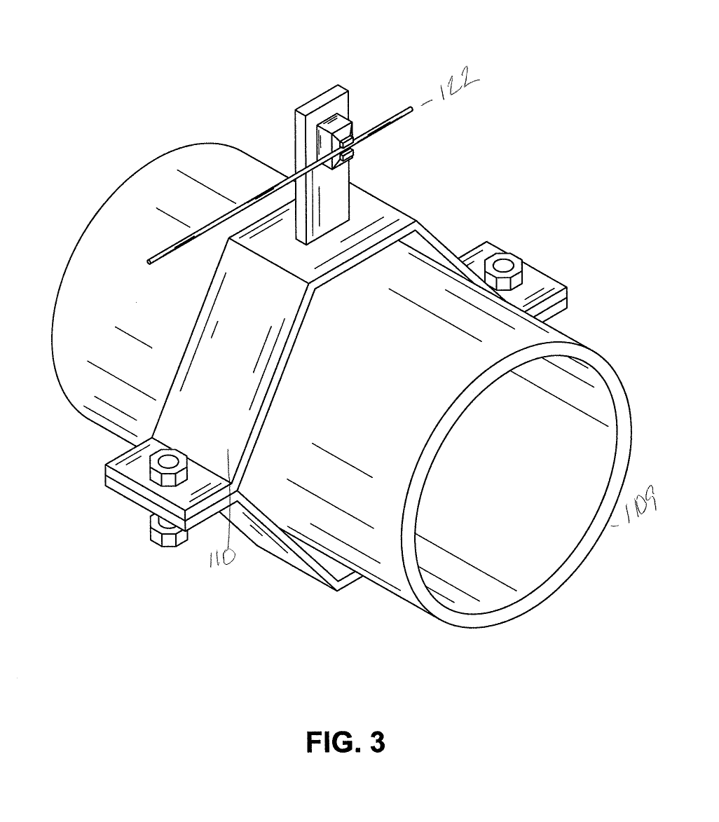

FIG. 4 shows a wire curtain with an insulated wire.

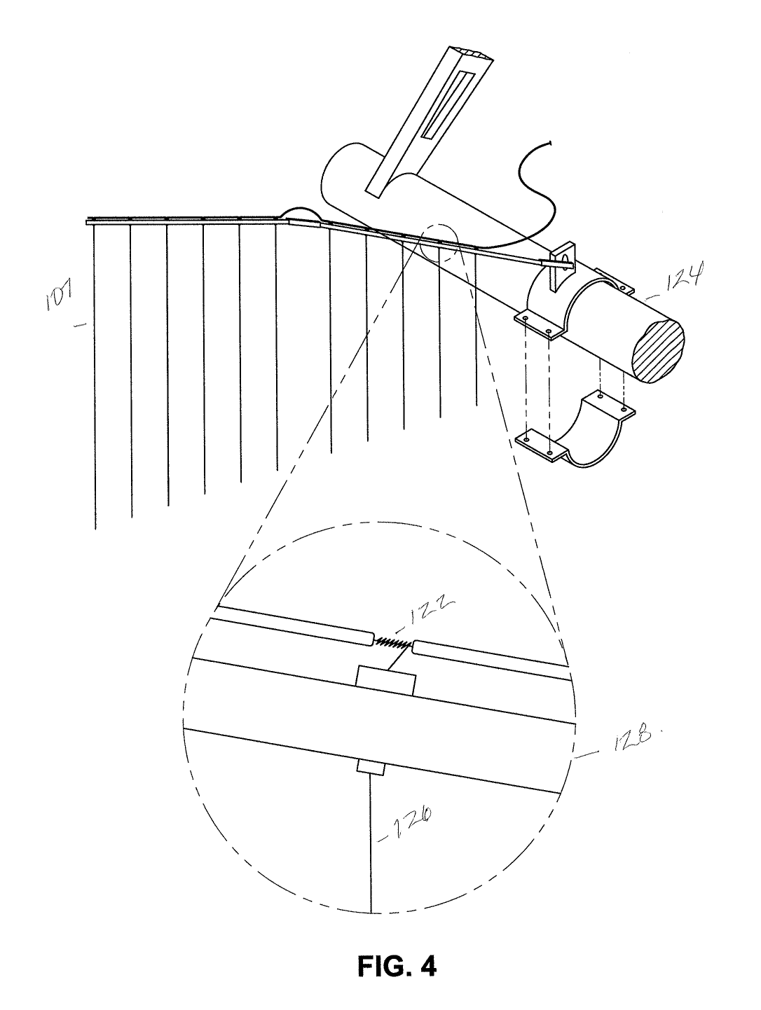

FIG. 5 shows an aerial view of the electric fence attached to a pivot in the field.

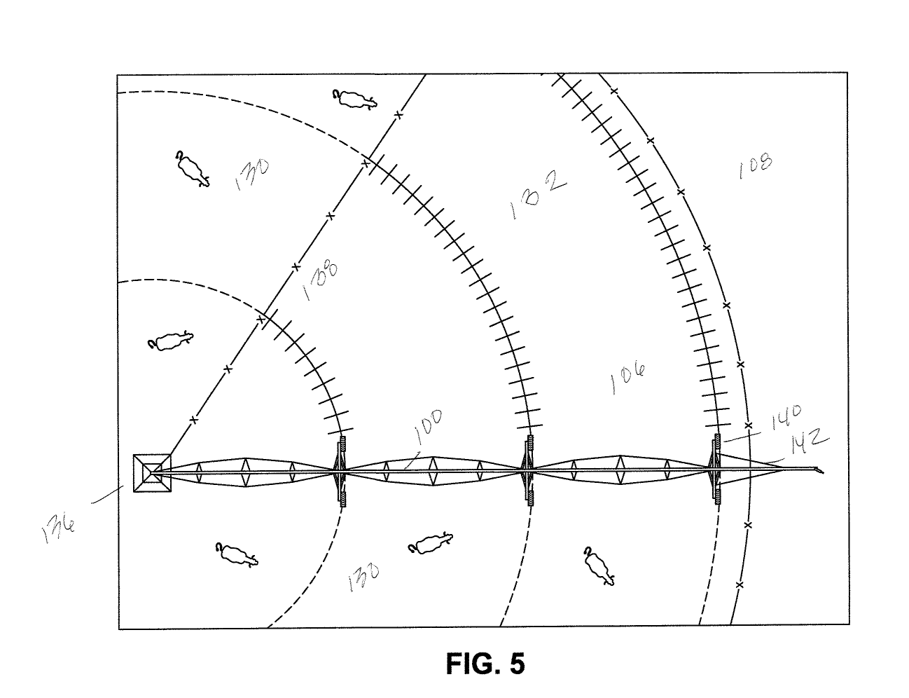

### DESCRIPTION OF THE PREFERRED EMBODIMENT

Disclosed is a movable electric fence for limiting the grazing area of herd animals. The fence prevents overeating and trampling of food and results in even distribution of manure. The device adapts a center pivot irrigation system into a moveable and portable fence by placing the fence on the center pivot structure. The parts comprising the fence are designed to quickly attach to any center pivot or lateral move irrigation system. In general, the invention is comprised of three main components: truss rod hangers 102, drive pipe clamps with insulators 110 126 and an automatic wire tensioner system 104. An electric wire 100 is suspended beneath the radial arm of a center pivot. The center pivot moves the electric wire radially about the center pivot's axis to allow the herd access to un-grazed 132 portions of the field as the center pivot progresses.

The Truss Rod Hangers 102 are the vertical post that stabilizes the height of the electrified wire 100 and insulate it from the rest of the pivot structure. It attaches to truss rods 119 at producer set intervals. There is a manual height adjustment at the center hub of the device. As the topography of the crop field changes the wire height will have to be adjusted, up or down. This unique feature gives the livestock producer the opportunity to maintain the proper wire height on rough crop fields. This center hub also functions as a break away in case the post comes in contact with the soil surface as the pivot moves.

The truss rod hangers 102 suspend the electric wire 100 beneath the center pivot. The preferred embodiment of the truss rod hangers 102 have two arms 114 that are pivotally connected together at one end forming a joint. The remaining ends of each arm have a pair of hooks 120 large enough to attach to the trusses of the center pivot. Having two hooks 120 on each arm adds stability to the truss rod hangers. For each pair, one of the hooks is directly in line with the arm while the other hook branches away from the arm. For one of the pairs of hooks, the hook branching away from the arm is set back from the hook in line with the arm to compensate for the curvature of the center pivot trusses. (The inventor realizes an alternative embodiment could comprise other ways of adding stability to the truss rod handers).

Drive Pipe Clamps 110 attach to the pivot tower drive pipes 109. It stabilizes the wire height in a fixed position and insulates the electrified wire from the pivot structure. The Wire Tensioner 104 attaches to the pivot point. The user can set wire tension by extending the spring with a cam strap. The wire tensioned by the extension spring can adjust its length as the pivot moves throughout the field without breaking. The tensioned wire also minimizes wire sagging and can allow a Truss Rod Hanger 102 spacing of up to 60 foot.

The Pivot Fence ends at the last tower 140 of the center pivot. To make the Pivot Fence independent of the outer perimeter fence 108, a temporary fence 138 is placed at the perimeter of the last tower pivot track. A second stationary fence is placed from the pivot point to the outer perimeter fence 142. The initial grazing area 130 is between the movable pivot fence and the stationary fences. The center pivot can be moved at any time from either the control panel or remotely if the system has telemetry and remote operation capability. The fence can be moved easily on frozen soils as long as the wheels are not frozen to the ground. This is minimized in windrow grazing systems by swathing the windrow over the pivot tracks. This way the pivot wheels will be traversing on dry windrow rather than in an old pivot track depression that could freeze at times of the year when the temperatures are near freezing.

The electric wire 100 is suspended from detachable fence posts attached to the trusses 119 and drive pipes 109 of the center pivot. The detachable fence posts are comprised of truss rod hangers 102 which act to suspend the electric wire 100 from the center pivot trusses 119, and of apparatuses (clamps) 110 for suspending the electric wire 100 from the center pivot drive pipes 109. (While the preferred embodiments of the fence posts are removable, the inventor realizes the fence posts could suspend the electric wire if the fence posts were permanently attached to the center pivot). (While the preferred embodiments of the fence posts are connected to the center pivot's trusses and drive pipes, the inventor realizes the fence posts could attach to other parts of the center pivot). Attached to the drive tower furthest from the center pivot's axis (hereinafter, referred to as the last drive tower) 140 is a wire curtain 107 to prevent animals from going between the movable electric fence and a perimeter fence 108.

In the preferred embodiment, the electric wire 100 is attached to one of four posts positioned evenly around and near to the center pivot's axis. The wire is attached via a tension spring 104 to ensure constant tension in the electric wire as the pivot arm progresses. The design also prevents animals from going between the center pivot's axis and the electric wire. The remaining end of the electric wire is secured to the last drive tower 140.

A connector draws the arms together and holds them in place. In the preferred embodiment, a single chain 116 attaches to the approximate midpoint of the arms' lengths. The chain is long enough to allow the arms to pivotally open wide enough to easily attach the arms' hooks 120 to the center pivot trusses 119. Once the hooks are attached, a generic load binder 117 attaches to two links of the chain and draws the arms together. The load binder keeps sufficient tension on the arms to prevent the hooks from coming off of the trusses.

The arms' ends forming the joint are comprised of plates 113 attached to the arms. The plates have holes suitable for a bolt. The joint is formed by placing a bolt through holes of the plates. A spacer is placed on the bolt between the plates to allow the arms to move. A final plate suitable for attaching a vertical rod is placed on the bolt. A washer and nut keep the pieces of the joint together.

A vertical post 118 descends from the joint. In the preferred embodiment, the rod adjustably connects to the plate held in the joint described above. The rod's distance from the ground adjusts at the joint using friction and compression by a cam lever. The joint also serves as a safety break away should the post contact the ground. The rod is ½ inch rebar commonly used for temporary electric fences although the inventor acknowledges other materials could be used. A plastic insulator 122 attaches to the rod and holds the electric wire.

As mentioned above, the electric wire 100 is also suspended by fence posts comprised of apparatuses for suspending the electric wire to the center pivot drive pipes 109. In the preferred embodiment, each of the apparatuses is comprised of a two-piece clamp. 112 The clamp pieces fit over the center pivot drive pipe and connect together with nuts and bolts. A support attached to the top piece of the clamp holds a plastic insulator 126 which holds the electric wire.

A wire curtain 107 attaches to the last drive tower 140 and spans the gap between the drive tower and the perimeter fence 108. The wire curtain prevents animals from passing between the drive tower and the perimeter fence. In the preferred embodiment, a clamp 110 attaches to the drive pipe of the drive tower in a fashion similar to the fence post clamping apparatus described above. The curtain is comprised of a curtain rod and stinger wires. One end of the curtain rod attaches to the top of the clamp. The other end extends away from the center pivot's axis toward the perimeter fence. Cables attached to the drive tower support the curtain's weight by attaching to a point on the curtain rod several feet from the curtain's end connected to the clamp. The inventor realizes alternative embodiments may include attaching a ring to the curtain rod several feet from the curtain's end connected to the clamp. Chains or cables could then support the curtain's weight by connecting from one angular support of the drive tower, through the ring, to the other angular support of the drive tower.

As mentioned above, the end of the electric wire is secured to a stable point on the last drive tower. It is secured near where the wire curtain attaches to the drive pipe. An additional wire connects to the electric wire to supply electricity to the wire curtain. A new electric wire extends along the length of the curtain rod. Stingers comprised of electric wire connect to the curtain rod's wire for electricity. The stingers are spaced narrowly enough to prevent animals from passing between the stingers. The stingers descend from the curtain rod low enough to prevent animals from going under the stingers, yet high enough to prevent the stingers from touching the ground on uneven terrain.

Because the perimeter fence may not be perfectly circular about the center pivot's axis, the distance between the perimeter fence and the last drive tower may vary. In the preferred embodiment, the curtain rod contains a joint near its midpoint which allows the herdsperson to remove the far half of the curtain to adjust for the varying distance between the perimeter fence and the last drive tower.

Disclosed is a system for controlling the movement of animals in a field, specifically, limiting their access to un-grazed portions of the field. The system is comprised of a movable electric fence as described above, a stationary perimeter fence, and a stationary radial fence. The perimeter fence prevents the animals from leaving the field and is placed close enough to the end of the center pivot that the animals are unable to pass between the movable electric fence and the perimeter fence. The radial fence prevents the animals from going around the axial end of the movable electric fence. In the preferred embodiment, the perimeter fence and the radial fence are constructed of rebar posts, insulators, and electric wires which are commonly used by others skilled in the art. The preferred system begins with the movable electric fence positioned far enough from the radial fence to allow the animals room to move, but near enough to prevent unnecessary trampling of the vegetation by the animals. Once the animals are enclosed between the radial fence, the movable electric fence, and the perimeter fence, the movable electric fence is progressed away from the animals. As the movable electric fence progresses, more vegetation becomes available for the animals to eat. The movable electric fence's progression rate is adjustable allowing the herdsperson to control the amount of vegetation per unit time available to the animals.

1. A system comprising truss rod hangers, drive pipe clamps with insulators, and an automatic wire tensioner system.

2. The system of claim 1, further comprising an electric wire suspended from said truss rod hangers, and means for connecting said electric wire to said drive pipe clamps with insulators.

3. A fence comprising means for attachment to a pivot, an electric wire for preventing animals from crossing, detachable fence posts for connecting the electric wire beneath said pivot to at least one truss and at least one drive pipe on said pivot, an automatic wire tension adjuster and a wire curtain for preventing animals from crossing, wherein said fence is supported by and moved radially about said pivot's axis.

4. The fence of claim 3, further comprising two arms pivotally connected at one end forming a joint, the distal end of each arm comprising a hook for attaching a truss rod hanger to said at least one truss, and a connector for drawing together and holding together the arms.
